(19) United States
(12) Patent Application Publication
(10) Pub. No.: US 2005/0037117 A1
(43) Pub. Date: Feb. 17, 2005

(54) Method for producing beverage having chlorophyll

(76) Inventors: Susumu Takayama, Niigata (JP); Chulwoo Lee, Ulsan (FR); Hangkyu Park, Pusan (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/485,954

(22) PCT Filed: Aug. 13, 2001
(86) PCT No.: PCT/JP01/07006

(51) Int. Cl. A23L 1/28

(52) U.S. Cl. 426/425

(57) ABSTRACT

A method for producing a beverage containing chlorophyll which has water and, dispersed therein, a material 16 containing chlorophyll and an oil and/or fat component having been extracted from a mixture 10 of excreta of silkworms (main component), leaves of a mulberry tree, and the like, characterized in that it comprises the steps of admixing the chlorophyll containing material 16 and a treating water at a given ratio and of subjecting the resulting mixture to an ultrasonic emulsification treatment, wherein the treating water 17 is substantially free of (1) fine solid particles dispersed therein, (2) a bacterium or a virus putrefying the chlorophyll containing material 16, (3) a substance reacting with the chlorophyll containing material 16 and (4) a substance coagulating a dispersion of the chlorophyll containing material 16. The method can be employed for taking out chlorophyll with good efficiency and for producing a chlorophyll containing beverage which can be stored without losing the freshness of chlorophyll.

### TECHNICAL FIELD

The present invention relates to a method for producing a beverage having chlorophyll by extracting chlorophyll contained in excreta of silkworms efficiently, the beverage being capable of being stored without losing the freshness thereof.

### BACKGROUND ART

Leaf green which is called chlorophyll is a green pigment existing in a stroma of a vegetable's chlorophyllose cell with carotene, lutein, xanthophyll and the like. The chlorophyll is applied to healthy foods processed in the form of beverages, powders, tablets or the like because chlorophyll has effects such as facilitating recovery of a burn or a skin disease and preventing an offensive odor or the like.

Above all beverages drunk as healthy foods are conventionally produced by steps of washing vegetable leaves or stems, pulverizing the materials in scraps by a mechanical pulverizing means such as a juicer, a blender or the like, as needed, and squeezing the pulverized materials. However, by the conventional method, a large amount of chlorophyll could not be extracted for the reason that chlorophyll exists in a hard cell membrane of the vegetable. Therefore, a beverage produced by the conventional method did not contain enough amount of chlorophyll to have the above-mentioned effects.

To solve this problem, there was another method for extracting chlorophyll from natural vegetable leaves or stems comprising steps of immersing the vegetable leaves or stems in an organic solvent like acetone which is harmful to humans, taking out chlorophyll by a mechanical extraction method, and processing the organic solvent for removal. However, the method had difficulty in removing the organic solvent perfectly and incapability of obtaining a chlorophyll-containing compound having highly purified chlorophyll.

For example, in published Japanese Patent Application Laid-Open No.S56-67501, a method for extracting chlorophyll contained in vegetable's leaves or stems efficiently by an extraction device utilizing ultrasonication was proposed. Another method for extraction of chlorophyll by utilizing a device described in published Japanese Patent Application Laid-Open No.S59-33231 comprises steps of charging a liquid-like ingredient containing excreta of silkworms or seaweed which are chlorophyll-containing materials with the alcoholic solvent in a tank, generating a circulation flow by pumping up the liquid-like ingredient from the tank and returning it to the tank again, and destroying vegetable cell walls and membranes of the ingredient by exposing the circulating liquid-like ingredient to an ultrasonic wave at outside of the tank.

However, the chlorophyll-containing compound was undrinkable with the alcoholic solvent. Moreover, since the extracted chlorophyll-containing compound contains a lot of fat besides the chlorophyll, the compound was difficult to be dissolved in water. The chlorophyll-containing compound being made to be dispersed in water, dispersing was not carried out perfectly, so that the water and the chlorophyll-containing compound separate into layers. As a result, the chlorophyll-containing compound was usually decomposed in a short term. Since said beverage for sale such as green juice produced by squeezing pulverized vegetable leaves or stems decayed in a day because of separation into the layers of green cell components and the water, the beverage was refrigerated to keep its freshness. However the beverage has little effect because the beverage has not sufficient chlorophyll whose cell membrane is destroyed.

Thus, the prior arts had difficulties to dilute the chlorophyll-containing compound with water evenly and efficiently in case of using the chlorophyll-containing compound as a material of food or cosmetics besides the beverage because an extracted chlorophyll-containing compound contains a lot of fat.

For producing a healthy food by processing the extracted chlorophyll-containing compound in a state of easily consumption, a method has been also proposed in accordance with a manner of chlorophyll pharmaceuticals described in published Japanese Patent Application Laid-Open No.H2-83329, the method comprising steps of removing residues from liquid-like ingredient whose vegetable cell walls and membranes are destroyed, kneading the residues with a protein-containing compound, and forming the residues into a granular or powdery product. However, emulsifying water could not be made from the product because the product was not dispersed in water. Therefore, when the formed product is blended with the water, a protein which is solid content in a protein-containing compound connecting with a chlorophyll component in the chlorophyll-containing compound, the blended product and the water being separated, the product decomposing in 3 days, and commercial values of the product would be lost. The product cannot be used in products needing no protein, e.g. cosmetic essences, because the formed product contains a lot of protein. In addition, children or the elderly who have difficulty to take in solid food cannot have the product with ease, and they cannot acquire the advantages of the chlorophyll.

Moreover, when the chlorophyll-containing compound is used for a tasty food whose taste and flavor are regarded as important, the chlorophyll-containing compound is premixed with an enzyme in accordance with a method described in published Japanese Patent Application Laid-Open No.S59-25694, for the purpose of removing a particular scent of the chlorophyll-containing compound. In the case of adding the mixture to the tasty food, the mixture must be further mixed with other ingredients of the tasty food. The conventional method of mixing has a problem that, by adding the enzyme, purity of the chlorophyll decreases and oxidization of the chlorophyll is accelerated, which results in deterioration and short-life of the product. In addition, as the chlorophyll-containing compound in the mixture contains a lot of fat, the compound cannot be dispersed in water as it is. Since the chlorophyll becomes unstable by mixing with the enzyme, the chlorophyll-containing compound is hard to be preserved for a long term because of being subject to chemical modification.

As mentioned above, a chemical structure (porphyrin core) of chlorophyll existing in the vegetable cell walls and membranes, is well known to have a property to connect with various substances easily, and to have a superior particularity to act on only harmful substances selectively even if those substances are harmless to other substances. Therefore, when chlorophyll is extracted from the vegetable cell walls and membranes, the chlorophyll becomes so unstable that a molecular modification of the chlorophyll is caused by oxygen in the air, heat or a solvent. As a result, the chlorophyll produces a derivative which is similar to the chlorophyll in molecular structure, so that it is impossible to commercialize chlorophyll products without damaging effective substances of the chlorophyll or to preserve its freshness.

The present invention has been achieved in view of the above-mentioned circumstances, and aims to provide a method for efficiently producing a beverage having chlorophyll by extracting chlorophyll from the excreta of silkworms, and for preserving the beverage having chlorophyll to stay fresh.

### DISCLOSURE OF INVENTION

The method for producing a beverage having chlorophyll attaining the above objects includes a process of dispersing a chlorophyll-containing compound containing an oil and/or fat component, extracted from excreta of silkworms in water, wherein the process comprises steps of admixing the chlorophyll-containing compound and a treating water at given ratio, and subjecting the resulting mixture to an ultrasonic emulsification treatment, the treating water used for the process being substantially free of: (1) fine solid particles dispersed therein, (2) a bacterium or a virus putrefying the chlorophyll-containing compound, (3) a substance reacting with the chlorophyll-containing compound, and (4) a substance aggregating a dispersion of the chlorophyll-containing compound.

The excreta of silkworms is defined herein as a mixture of excrement of silkworms and one of rice chaff used for removing lees, scraps of mulberry leaves, shed shells of the silkworms and the like; the excreta of silkworms selected from the mixture; or the excreta of silkworms to which dried silkworms are added. The chlorophyll-containing compound containing the oil and/or fat component is defined herein as that from which fiber of cell walls and the like is removed, generally including fat or proteins besides chlorophyll.

In the method of the present invention for producing the beverage having chlorophyll extracted from the excreta of silkworms, since an ultrasonic-emulsification is given to the chlorophyll-containing compound containing the oil and/or fat component and water, the chlorophyll-containing compound can be efficiently dispersed in the treating water and emulsified in a drinkable state. In addition, a use of the treating water satisfying the above-mentioned conditions (1) to (4) can prevent chlorophyll contained in the chlorophyll-containing compound from connecting with substances contained in ordinary water. The treating water can be pure water (including a distilled water or a purified water by utilizing an ion-exchange resin).

To take concrete examples of the treating water having properties of the conditions of (1) to (4), the examples include a sterilized natural water (e.g. a mineral water), wherein impure substances are removed, a distilled water wherein a residual chlorine is removed, a boiled water wherein impure substances are removed, and a sterilized tap water wherein the chlorine and the impure substances are removed. In addition, a natural water contains minerals which are compatible to the chlorophyll-containing compound can be used as far as the natural water has the properties of the conditions of (1) to (4). In this manner, since the treating water from which impurities (including metal ions) affecting the beverage on its deterioration or discoloration are removed is used, the deterioration and the discoloration of the beverage can be restrained.

Furthermore, the chlorophyll-containing compound can be used as a material of food besides the beverage with a mixing ratio of the chlorophyll-containing compound to the treating water being between 1:20 and 1:1000 by weight. In this case, the food comprises, for example, bread, gum, a caramel or the like.

The chlorophyll-containing compound can be used as a material of cosmetics besides the beverage with a mixing ratio of the chlorophyll-containing compound to the treating water being between 1:20 and 1:1000 by weight. In this case, the cosmetics comprise, for example, pomades, soaps, face essences or the like.

In this intention, in case of a mixing ratio of the chlorophyll-containing compound to the treating water being 1 to less than 20 by weight, the chlorophyll-containing compound cannot be emulsified sufficiently and evenly because of fat contained in the chlorophyll-containing compound. Meanwhile, in case of the mixing ratio being 1 to over 1000, the advantages of the chlorophyll-containing compound cannot be sufficiently obtained, since the quantity of the chlorophyll-containing compound in the food or the cosmetics is decreased. Therefore, the mixing ratio is preferably between 1:30 and 1:800 by weight, more preferably between 1:30 and 1:600, whereby the chlorophyll-containing compound can be kneaded sufficiently with the other ingredients of the food or the cosmetics and the advantages of chlorophyll can be obtained sufficiently.

The mixture with the mixing ratio of the chlorophyll-containing compound to the treating water being between 1:30 and 1:1000 by weight can be drunk for a medicinal use. As objective diseases of the medicinal use, it is possible to list for example, chronic renal failure, liver cirrhosis, cancer of the liver, cancer of the breast or the like.

In the mixture, if the mixing ratio of the chlorophyll-containing compound to the treating water is 1 to less than 30 by weight, a patient has a difficulty to drink the chlorophyll-containing compound because of the excess fat contained in the chlorophyll-containing compound. Meanwhile, if the mixing ratio is 1 to over 1000, the advantages of the chlorophyll-containing compound cannot be sufficiently obtained as the quantity of the chlorophyll-containing compound included in the treating water is decreased. Accordingly, the mixing ratio is preferably between 1:60 and 1:800 by weight, more preferably between 1:60 and 1:600 by weight, whereby the chlorophyll-containing compound can be easily drinkable and the advantages of chlorophyll can be obtained sufficiently.

The chlorophyll-containing compound can be drunk as a health-promoting beverage with the mixing ratio being between 1:30 and 1:1000 by weight.

In addition, in the case of the mixing ratio being 1 to less than 30 by weight, the chlorophyll-containing compound is hard to drink as beverage because of the fat contained in the chlorophyll-containing compound. Meanwhile, in case of the mixing ratio being 1 to over 1000, the quantity of the chlorophyll-containing compound in the treating water is decreased; a flavor of the beverage is lost; and the effect of chlorophyll-containing compound is also rather weaken. Therefore, the mixing ratio is preferably between 1:50 and 1:800 by weight, more preferably between 1:60 and 1:600 by weight so that not only the mixture is easily drinkable and flavorful but also the mixture provides the effect of the chlorophyll-containing compound.

Furthermore, the method of the present invention preferably comprises steps of putting the chlorophyll-containing compound and the treating water into a first tank, the treating water being a disperse medium, transferring a liquid mixture (A) of the chlorophyll-containing compound and the treating water from the first tank to a second tank through a first connection pipe, the liquid mixture (A) being stirred and mingled in the first tank, the first connection pipe having a first ultrasonic-emulsification device halfway, the liquid mixture (A) being dispersed by an ultrasonic wave with the device, and returning the liquid mixture (A) in the second tank from the second tank to the first tank through a second connection pipe, the liquid mixture (A) being stirred and mingled in the second tank, the second connection pipe having a second ultrasonic-emulsification device halfway, the liquid mixture (A) being dispersed by the ultrasonic wave with the device, wherein the chlorophyll-containing compound is blended and dispersed in the treating water to be in an emulsion state by repeating the transferring step and the returning step.

The ultrasonic-emulsification device, as used herein, is that which can produce emulsion by emulsifying fat content and the treating water with exposing fluid thereof to the ultrasonic wave which is not less than 20,000 Hz. As described above, the chlorophyll of the liquid mixture (A) can be prevented from oxidizing by containing products made of the liquid mixture (A) in the sealed tanks. Since the liquid mixture (A) can be also transferred between the first tank and the second tank, stagnation of the liquid mixture (A) is decreased in comparison with a case of circulating the liquid mixture (A) in only one tank. As a result, the ultrasonic dispersion can be carried out equally all over the liquid mixture (A), and the liquid mixture (A) can be certainly emulsified by short-term exposure of the ultrasonic wave. Namely if emulsification is carried out by circulating the liquid mixture (A) in one tank, stagnation and slow flows of the liquid mixture (A) occur in some parts of the tank. As a result, the emulsification becomes difficult. Accordingly, the exposure time of the ultrasonic wave (i.e. necessary time to emulsify a unit quantity of ingredients nearly completely) becomes longer. Furthermore, since a part of the liquid mixture (A) is exposed longer, some trouble happen in the efficiency and freshness because of deterioration of chlorophyll component. In addition, exposing time of the ultrasonic wave being shorter, a small amount of fat remains therein because of incomplete emulsification. The fat content being a cause of an order, long-term preservation of the product becomes difficult.

In the method of the present invention, it is possible that both end sides of the first and the second connection pipes are comprised of a first to a fourth branch pipes respectively, the first to the fourth branch pipes being connected with liquid inlets and liquid outlets of the first tank and the second tank respectively through a first to a fourth valves, middle portions of the first and the second connection pipes are comprised of a common pipe whereon an ultrasonic vibrator working as not only the first ultrasonic-emulsification device but also the second ultrasonic-emulsification device, and a pump providing the liquid mixture (A) to the ultrasonic vibrator are arranged in series, and treatments in the transferring step and the returning step are carried out by switching of the first to the fourth valves with operation of the pump. In accordance with such a manner, moving directions of the liquid mixture (A) through the common pipe can be the same in cases of the liquid mixture (A) moving from the first tank to the second tank and the liquid mixture (A) moving from the second tank to the first tank. Therefore, the configuration of the pump and the ultrasonic vibrator can be simplified.

It is possible to obtain the chlorophyll-contained compound by steps of extracting the chlorophyll-containing compound from the excreta of silkworms by dissolving the excreta of silkworms containing chlorophyll in a volatile solvent with ultrasonication, separating unnecessary residues from liquid produced in the extracting step by a means of filtering or centrifugation, and evaporating the solvent from chlorophyll-containing liquid produced in the separating step. As the solvent, alcoholic solution, e.g. ethanol, is used.

It is possible that, in the extracting step, a liquid mixture (B) of the volatile solvent and the excreta of silkworms being transferred alternately between a third and a fourth tanks, the third and the fourth tanks being connected by a connection pipe having an ultrasonic-solution device halfway, the liquid mixture (B) being stirred and mingled in the third and the fourth tanks, extraction of chlorophyll contained in the excreta of silkworms is facilitated by the ultrasonic-solution device.

In addition, in the extracting step, it is possible to use a device of the same structure as used in emulsifying the chlorophyll-containing compound containing oil and/or fat component in the treating water. In this case, the first tank and the second tank are used as the third tank and the fourth tank respectively, and the ultrasonic-emulsification device comprising the ultrasonic vibrator operates as the ultrasonic-solution device.

In the present invention, the chlorophyll-containing compound is extracted from the excreta of silkworms, so that chlorophyll can be efficiently obtained and purity of chlorophyll contained in the product can be enhanced. In addition, since the ultrasonication disintegrates the vegetable cell walls and membranes, chlorophyll can be extracted more efficiently.

Furthermore, tablets can be made from the residues produced in the separating step by kneading the residues with the chlorophyll-containing compound or emulsion including the chlorophyll-containing compound dispersed in the treating water after removing the solvent from the residues by drying. The residues can be obtained by adjusting a centrifuge to leave a specified quantity of the chlorophyll-containing compound in the residues. It is also possible to add the chlorophyll-containing compound produced in the evaporating step to the residues directly. In accordance with the above-mentioned manner, the tablets can be produced from solid material generated normally as waste in the conventional techniques, thus a mass production of the beverage having chlorophyll is realizable with eliminating a loss of materials.

### BRIEF DESCRIPTION OF DRAWINGS

FIG. 1 is a flow chart of a method for producing the beverage having chlorophyll in accordance with an embodiment of the present invention.

FIG. 2 is an illustration of an apparatus used in the method.

FIG. 3 is a sectional view of an ultrasonic vibrator used in the apparatus.

FIG. 4 is an explanatory graph of a medical case (1) wherein a patient drank the beverage for a medicinal use, the beverage being produced by a method for producing the beverage having chlorophyll in accordance with an embodiment of the present invention.

FIG. 5 is an explanatory graph of a medical case (2) wherein a patient drank the beverage produced by the method for a medicinal use.

FIG. 6 is an explanatory graph of a medical case (3) wherein a patient drank the beverage produced by the method for a medicinal use.

### BEST MODE FOR CARRYING OUT THE INVENTION

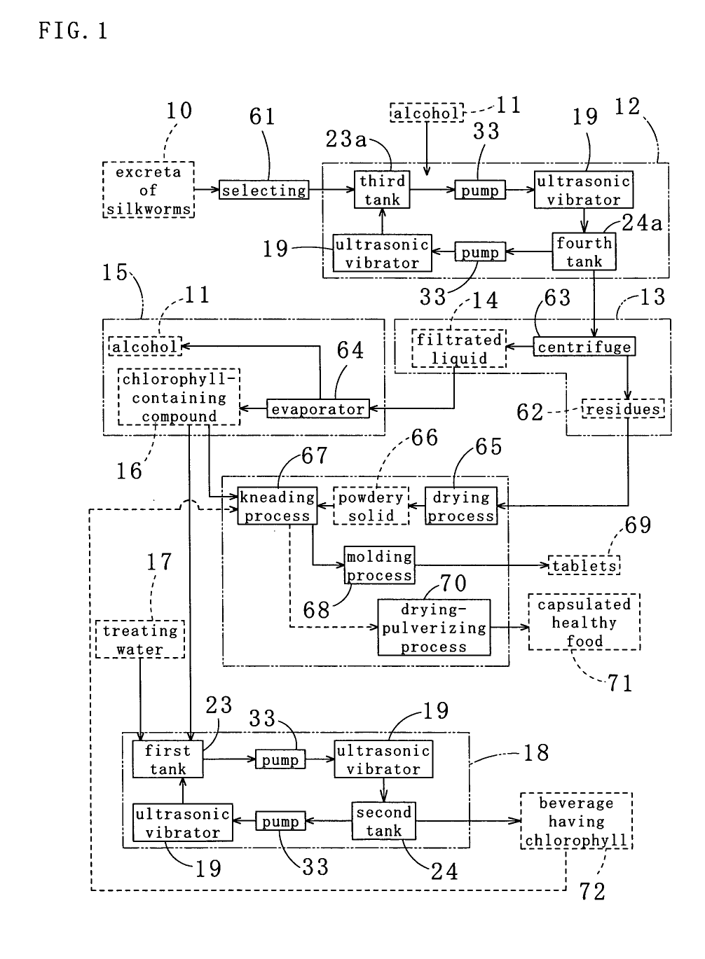

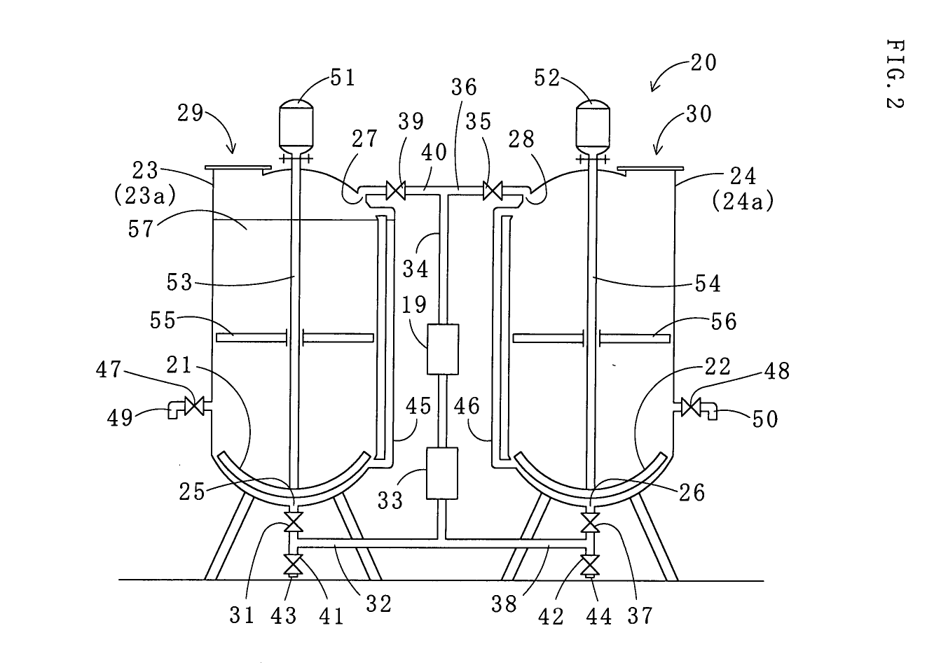

As shown in FIG. 1, a method for producing a beverage having chlorophyll in accordance with one embodiment of the present invention, in summary, comprises extracting step 12 of extracting chlorophyll by dissolving excreta of silkworms 10 which are mainly excrement of silkworms in an alcohol 11, residue separating step 13 of separating solid residues 62 from liquid (i.e. chlorophyll extract) produced in the extracting step 12, solvent evaporating step 15 of separating the alcohol 11 from filtrated liquid 14 (i.e. chlorophyll-containing liquid) produced in the residue separating step 13, and emulsifying step 18 of dispersing a chlorophyll-containing compound 16 (i.e. essences) containing an oil and/or fat component produced in the evaporating step 15 in a treating water 17 (e.g. a pure water). In this embodiment, an apparatus 20 for producing the beverage having chlorophyll as shown in FIG. 2 is used in the extracting step 12 and the emulsifying step 18, the apparatus comprising an ultrasonic vibrator 19.

In a detailed explanation hereinafter of this embodiment, the apparatus 20 for producing the beverage having chlorophyll is firstly described, and the method for producing the beverage having chlorophyll with the apparatus 20 is described secondly.

As described above, the apparatus 20 is used for the purpose of extracting chlorophyll from the excreta of silkworms 10 in the alcohol 11, and for the purpose of emulsifying the chlorophyll-containing compound 16 containing the oil and/or fat component in the treating water 17 which is a dispersion medium. The apparatus 20 has a first tank 23 and a second tank 24 which comprise stirring blades 21,22 respectively, the stirring blades 21, 22 being examples of means of stirring. Liquid outlets 25, 26 are equipped at the lower portions of the first tank 23 and the second tank 24 respectively. In addition, liquid inlets 27, 28 and material inlets 29, 30 are equipped at the upper portions of the first tank 23 and the second tank 24 respectively.

The liquid outlet 25 of the first tank 23 is connected with the liquid inlet 28 of the second tank 24 via a first branch pipe 32 having a first valve 31, a common pipe 34 equipping a pump 33 and the ultrasonic vibrator 19 at a middle portion thereof, and a second branch pipe 36 having a second valve 35. Likewise, the liquid outlet 26 of the second tank 24 is connected with the liquid inlet 27 of the first tank 23 via a third branch pipe 38 having a third valve 37, the common pipe 34 equipping the pump 33 and the ultrasonic vibrator 19 at the middle portion thereof, and a fourth branch pipe 40 having a fourth valve 39.

In the embodiment, the ultrasonic vibrator 19 not only operates as an ultrasonic-solution device in the extracting step 12 but also operates as an ultrasonic-emulsification device in the emulsifying step 18. (This ultrasonic-emulsification device is an example of above-described the first and the second ultrasonic-emulsification device in said present invention). In the embodiment, a first connection pipe which connects the first tank 23 with the second tank 24 is comprised of the first branch pipe 32, the common pipe 34 and the second branch pipe 36. Likewise, a second connection pipe which connects the second tank 24 with the first tank 23 is comprised of the third branch pipe 38, the common pipe 34 and the fourth branch pipe 40. Furthermore, the first to the fourth branch pipes 32, 36, 38, 40, and the common pipe 34 also function as a connection pipe which connects the first tank 23 with the second tank 24, the connection pipe having the pump 33 and the ultrasonic vibrator 19 at the middle portion thereof.

At the location right under the first valve 31 and the third valve 37, discharging outlets 43,44 are equipped on contact with discharging valves 41, 42 respectively. By opening the discharging valves 41 and 42 with opening the first valve 31 and the third valve 37, all the liquid in the first tank 23 and the second tank 24 can be discharged respectively. Liquid level gauges 45, 46 to inspect the internal status of the tanks are equipped at the sides of the first tank 23 and the second tank 24 respectively. At the sides of the first tank 23 and the second tank 24, outlets 49, 50 for the purpose of experimentally discharging liquid therein are equipped respectively, the outlets 49, 50 comprising cocks 47, 48 respectively.

The stirring blades 21, 22 which are disposed at the lower portions of the first and the second tanks 23, 24 are equipped to rotating shafts 53, 54 which are driven by speed reducing motors 51, 52 disposed on the tops of the first tank 23 and the second tank 24 respectively. The rotating shafts 53, 54 are supported rotatably on the middle portions of the shafts by bearings 55, 56 respectively. In addition, the first tank 23 and the second tank 24 respectively have thermometers and cooling devices, which are not shown in the figures, so that the devices can prevent chlorophyll from being destroyed and losing its availability by temperature increase.

The first to the fourth valves 31, 35, 37, 39 are switched automatically by a control device which is not shown in the figures. When the first valve 31 and the second valve 35 are opened, the third valve 37 and the fourth valve 39 are closed. While the first valve 31 and the second valve 35 are closed, the third valve 37 and the fourth valve 39 are opened. More specifically, for example, when a liquid mixture 57 (an example of a liquid mixture (A) or (B)) moves from the first tank 23 to the second tank 24, the pump 33 operates with the first valve 31 and the second valve 35 opened and the third valve 37 and the fourth valve 39 closed. Then the liquid mixture 57 moving upwards inside the common pipe 34 through the first branch pipe 32 from the first tank 23, the liquid mixture 57 is introduced into the second tank 24 from the liquid inlet 28 through the second branch pipe 36. Meanwhile, when the liquid mixture 57 moves from the second tank 24 to the first tank 23, the first valve 31 and the second valve 35 are closed, and the third valve 37 and the fourth valve 39 are opened. Then the liquid mixture 57 moving upwards inside the common pipe 34 from the bottom of the second tank 24 through the third branch pipe 38 by operating the pump 33, the liquid mixture 57 is introduced into the first tank 23 from the liquid inlet 27 through the fourth branch pipe 40. In addition, to secure continuous operating of the pump 33, the third and the fourth valves 37, 39 are preferably opened just before closing the first and the second valves 31, 35, and the first and the second valves 31, 35 are preferably opened just before closing the third and the fourth valves 37, 39.

The capacities of the first tank 23 and the second 24 are respectively, for example, in the range between 100 litters and 500 litters, and amount of the liquid mixture 57 introduced into the tanks should be less than either capacity of the first tank 23 or the second tanks 24.

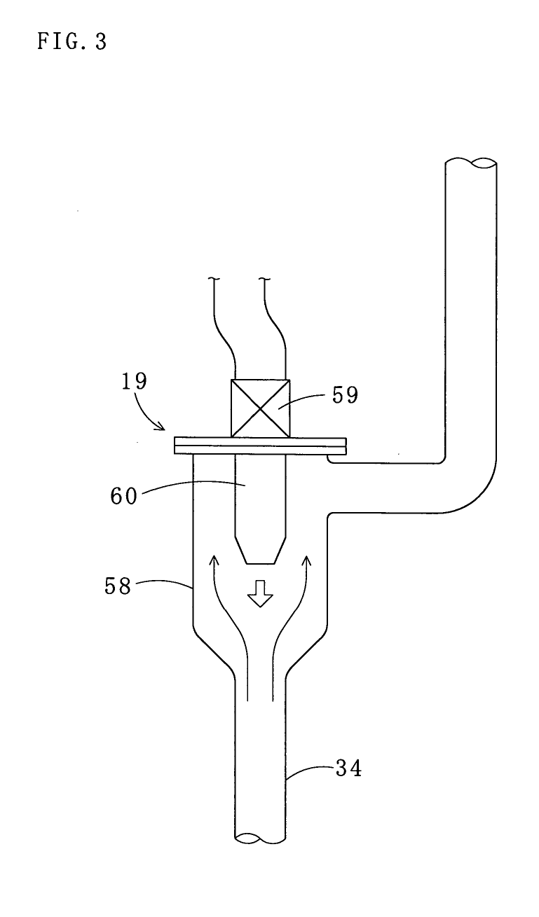

As an example of the ultrasonic vibrator 19 being shown in FIG. 3, the ultrasonic vibrator 19 comprises a widened liquid passageway 58, an oscillator 59 disposed in the passageway 58 and a horn 60 thereof, the oscillator 59 being capable of radiating an ultrasonic wave downwards. Frequency of the radiated ultrasonic wave is between 20 kHz and 100 kHz, whereby a scope of the invention cannot be limited. The liquid mixture 57 is exposed to the ultrasonic wave while rising up through inside of the liquid passageway 58 from the common pipe 34. In this case, emulsifying is promoted if the liquid mixture 57 is a mixture of the treating water (e.g. a pure water) and the chlorophyll-containing compound; extracting of chlorophyll contained in the excreta of silkworms is promoted if the liquid mixture 57 is a mixture of the excreta of silkworms and the alcohol. In addition, the ultrasonic vibrators 19 can be installed at two or more positions, namely at multi-positions, inside the common pipe 34. For example, in case of installing two ultrasonic vibrators, ultrasonication of the liquid mixture 57 operates efficiently when the two ultrasonic vibrators 19 are installed at a distance of 10 cm to 70 cm.

In the apparatus 20, since a transfer of the liquid mixture 57 between the first tank 23 and the second tank 24 is driven by opening the third valve 37 and the fourth valve 39 just before closing the first valve 31 and the second valve 35, and likewise, by opening the first valve 31 and the second valve 35 just before closing the third valve 37 and the fourth valve 39, the pump 33 can operate continually, as a result, the liquid mixture 57 passing through the common pipe 34 can be exposed to the ultrasonic wave efficiently. In addition, this invention is applied to a case wherein transferring and returning of the liquid mixture 57 are repeated between the first tank 23 and the second tank 24 by operating the pump 33 with the predetermined valve operations for opening and closing after the liquid mixture 57 sufficiently mixed in the first tank 23 and the second tank 24 with all the valves 31, 35, 37, 39 being closed.

The method for producing the beverage having chlorophyll by utilizing the apparatus 20 is explained hereinafter. For an easier understanding, the first and the second tanks 23,24 which are used in the emulsifying step 18 are marked as the first tank 23 and the second tank 24, while the first and the second tanks which are used in extracting step 12 are marked with other names and marks as a third tank 23a and a fourth tank 24a.

As shown in FIG. 1, the excreta of silkworms 10 mainly comprising excrement of silkworms can be available in the market. The excrement of silkworms contains lots of cells of mulberry which is main feed for silkworms. By dissolving the excrement of silkworms in an alcoholic solvent, chlorophyll can be obtained. The excreta of silkworms 10 are dried and alien substances thereof are removed. Although selecting 61 of alien substances can be carried out by wind power classifying or riddling, manual selecting can be carried out when an amount of the excreta of silkworms is small. Furthermore, it is possible to wash the excreta of silkworms 10 to separate the alien substances. Next, chlorophyll is extracted from the excreta of silkworms 10 in the extracting step 12, wherein the above-mentioned apparatus 20 is used. At first, the sorted 50 kg to 100 kg of excreta of silkworms 10 is prepared. Secondly, the excreta of silkworms 10 is put into the third tank 23a (or the fourth tank 24a) from the material inlet 29 (or 30) with, for example, 50 litters to 400 litters of the alcohol 11 which is a volatile solvent.

In the third tank 23a, the excreta of silkworms 10 and the alcohol 11 are mixed sufficiently by the stirring blade 21 driven by the speed reducing motor 51 to form the liquid mixture (B). Then the liquid mixture (B) is transferred from the third tank 23a to the fourth tank 24a by operating the pump 33 with the first valve 31 and the second valve 35 opened, and with the third valve 37 and the fourth valve 39 closed, after the liquid mixture (B) is introduced into the third tank 23a or after further mixing of the liquid mixture (B) for predetermined time is finished in the third tank 23a. In this process, since the liquid mixture (B) passes though the common pipe 34, an extraction of chlorophyll contained in the excreta of silkworms 10 is facilitated by an ultrasonic-solution device which is comprised of the ultrasonic vibrator 19. At the time when the liquid mixture (B) in the third tank 23a is completely transferred to the fourth tank 24a, the first valve 31 and the second valve 35 are closed just after the third valve 37 and the fourth valve 39 are opened. Hereby, the liquid mixture (B) is transferred from the fourth tank 24a to the third tank 23a by the pump 33. In the liquid mixture (B) of this process, the extraction of chlorophyll contained in the excreta of silkworms is facilitated by the ultrasonic-solution device which is comprised of the ultrasonic vibrator 19. At the time when the liquid mixture (B) is completely transferred from the fourth tank 24a to the third tank 23a, the third valve 37 and the fourth valve 39 are closed just after the first valve 31 and the second valve 35 are opened. By these valve operations, the liquid mixture (B) is transferred from the third tank 23a to the fourth tank 24a. As described above, with repetition of transferring and returning between the third tank 23a and the fourth tank 24a, the ultrasonic vibrator 19 destroys cell walls and membranes of vegetable cells of mulberry leaves contained in the excreta of silkworms 10 and the chlorophyll-containing compound is extracted in the alcohol 11. In this manner, the working time for extracting chlorophyll can be curtailed by exposing the excreta of silkworms 10 to ultrasonic vibration.

The liquid mixture (B) produced in the above-mentioned processes can be collected, for example, by opening the discharging valve 42 and the third valve 37 placed at the bottom of the tank 24a. The liquid mixture (B) comprising the alcohol 11, the chlorophyll-containing compound 16 and the residues 62 (solid material), the residues 62 are separated in the next residue separating step 13. A filtrating method can be used for separating the residues 62, however, a centrifugal method utilizing a centrifuge 63 is used in this embodiment. The filtrated liquid 14 (i.e. chlorophyll-containing liquid) and the solid residues 62 are separated by the centrifugal method. To enhance purity of the liquid, it is more preferable to accumulate the liquid separated by the centrifuge 63 in a precipitation tank so that residues which can not separated by the centrifuge may be deposited.

In solvent evaporating step 15, the chlorophyll-containing compound 16 is collected by putting the filtrated liquid 14 produced in the residue separating step 13 into an evaporator 64 to separate (i.e. to remove the alcohol 11 by evaporating) the alcohol 11 contained in the liquid. The chlorophyll-containing compound 16 is not soluble in the treating water 17 as it is, because of contained fat and proteins besides chlorophyll therein.

Additionally, since the residues 62 produced in the residue separating step 13 contain a lot of fiber, tablets 69 are made from the residues 62 by a kneading process 67 and a molding process 68 of the residues with the chlorophyll-containing compound 16 obtained in the solvent evaporating step 15 after making powdery solid 66 by a drying process 65 of the residues to remove the solvent. As needed, the drying process can be carried out before and/or after the molding process 68. Furthermore, an end product of beverage having chlorophyll 72, namely the emulsion, wherein the chlorophyll-containing compound 16 is dispersed in the treating water 17, can be added to the residues in the kneading process 67. In addition, capsulated healthy food 71 can be made from the residues 62 via the kneading process 67 with adding the powdery solid 66 and the chlorophyll-containing compound 16, the residues 62 being powderized in a drying-pulverizing process 70.

The emulsifying step 18 is described hereinafter, the emulsifying step 18 being a process, wherein the chlorophyll-containing compound 16 which comprises fat and proteins produced in the solvent evaporating step 15 is dispersed in the treating water 17 by utilizing the apparatus 20.

The chlorophyll-containing compound 16 containing the oil and/or fat component extracted from the excreta of silkworms is put into the first tank 23 (or the second tank 24) via the material inlet 29 with the treating water 17 (disperse medium) at a predetermined ratio of the chlorophyll-containing compound 16 to the treating water 17, and the chlorophyll-containing compound 16 and the treating water 17 are admixed by driving the stirring blade 21.

Hence, the treating water 17 is the water being substantially free of: (1) fine solid particles dispersed therein, (2) a bacterium or a virus putrefying the chlorophyll-containing compound 16, (3) a substance reacting with the chlorophyll-containing compound 16, and (4) a substance coagulating a dispersion of the chlorophyll-containing compound 16. In addition, since a pure water (a distilled water or a purified water by utilizing an ion-exchange resin) satisfies all the conditions (1) to (4), the pure water can be an embodiment of the treating water.

Furthermore, in case of chlorophyll contained in the chlorophyll-containing compound 16 being used as a material for food or cosmetics besides beverage, a mixing ratio of the chlorophyll-containing compound 16 to the treating water 17 is between 1:20 and 1:1000 by weight. In case of drinking the chlorophyll for a medicinal use, the mixing ratio is between 1:30 and 1:1000 by weight. In addition, in case of the chlorophyll being used as a healthy beverage, the mixing ratio is between 1:30 and 1:1000 by weight.

Furthermore, the present invention not being limited to the ranges, the mixing ratio of the chlorophyll-containing compound 16 to the treating water 17 can be changed in accordance with purposes of people's use or taste. In those cases, the present invention is also applied. The step of putting is comprised of the above-mentioned processes.

After the admixing for predetermined time is finished, the liquid mixture (A) is transferred to the second tank 24 by opening the first valve 31 and second valve 35 through the first connection pipe, wherein the first ultrasonic-emulsification device comprising the pump 33 and the ultrasonic vibrator 19 is equipped. The first connection pipe is comprised, as described above, of the first branch pipe 32, the common pipe 34 and the second branch pipe 36. Thus, the ultrasonic dispersing process is operated by the ultrasonic vibrator 19 which is equipped in the common pipe 34. The emulsification of the chlorophyll-containing compound 16 is facilitated by pulverizing the compound in small size and dispersing the compound in the treating water 17. The step of transferring is comprised of the above-mentioned processes.

After the liquid mixture (A) is transferred from the first tank 23 to the second tank 24 almost completely, the first valve 31 and the second valve 35 are closed after the third valve 37 and the fourth valve 39 are opened. By these valve operations, the liquid mixture (A) is returned (i.e. reverse-transferred) from the second tank 24 to the first tank 23 through the second connection pipe, wherein the second ultrasonic-emulsification device comprising the pump 33 and the ultrasonic vibrator 19 is installed after the liquid mixture (A) is further admixed by the stirring blade 22 in the second tank 24. In this process, the emulsification of the liquid mixture (A) is facilitated by the ultrasonic dispersing with the equipped ultrasonic vibrator 19. The step of returning is comprised of the above-mentioned process.

The above-described steps of transferring and returning comprise a step of ultrasonic-emulsifying which is operated after admixing the chlorophyll-containing compound 16 and the treating water 17 at a given ratio.

In mixture (A), the repetition of the above-mentioned steps of transferring and returning facilitates the emulsifying the chlorophyll-containing compound 16 in the treating water 17. In the described manner, all of the liquid mixture (A) can be transferred alternately between the first tank 23 and the second tank 24, and ultrasonic-emulsification by the ultrasonic vibrator 19 is applied to the liquid mixture (A) passing through the common pipe 34, which is a part of the first and the second connection pipes. As a result, more efficient emulsifying is carried out.

In addition, for the purpose of using chlorophyll contained in the chlorophyll-containing compound 16 for cosmetics or food, if a mixing ratio of the chlorophyll-containing compound 16 to the treating water 17 is, for example, 1:40, the chlorophyll contained in the chlorophyll-containing compound can be well mixed with the other materials which are comprised of the cosmetics or the food. Therefore, not only uniformized products can be produced but also workability thereof can be better.

Furthermore, for the purpose of using chlorophyll contained in the chlorophyll-containing compound 16 for a medicinal use (e.g. functional food, Chinese medicine or the like), a mixing ratio of the chlorophyll-containing compound 16 to the treating water 17 being, for example, 1:60, a patient has been drinking 5 cc to 15 cc thereof according to the patient's symptoms three times a day, whereby great effect has been found in the patient. If a patient has difficulty to drink the beverage, the beverage can be diluted with 50 cc to 100 cc of the treating water (drinkable water).

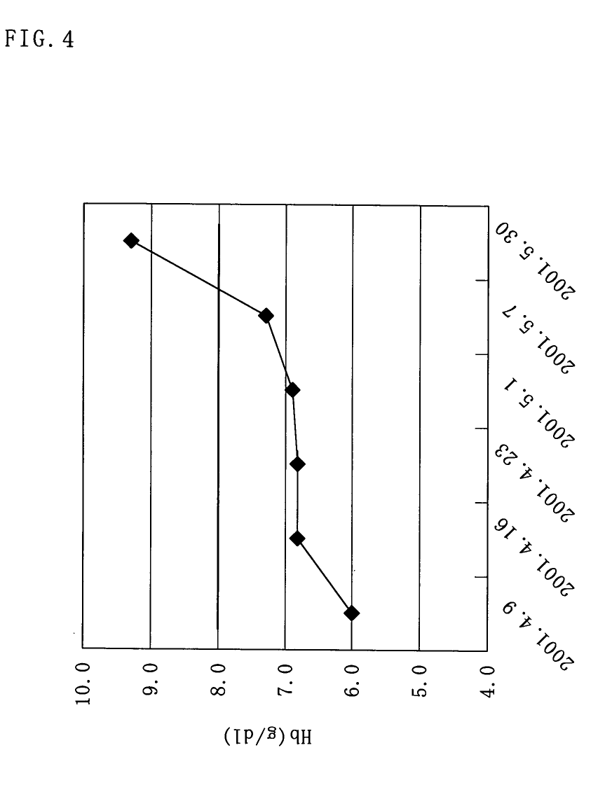

As shown in FIG. 4, in case of a female dialysis patient who was at her 50's and had chronicle renal failure and iron-deficiency anemia had kept drinking the beverage produced for a medicinal use, it is clear that hemoglobin scores (which shows an indicator of seriousness) had been improved.

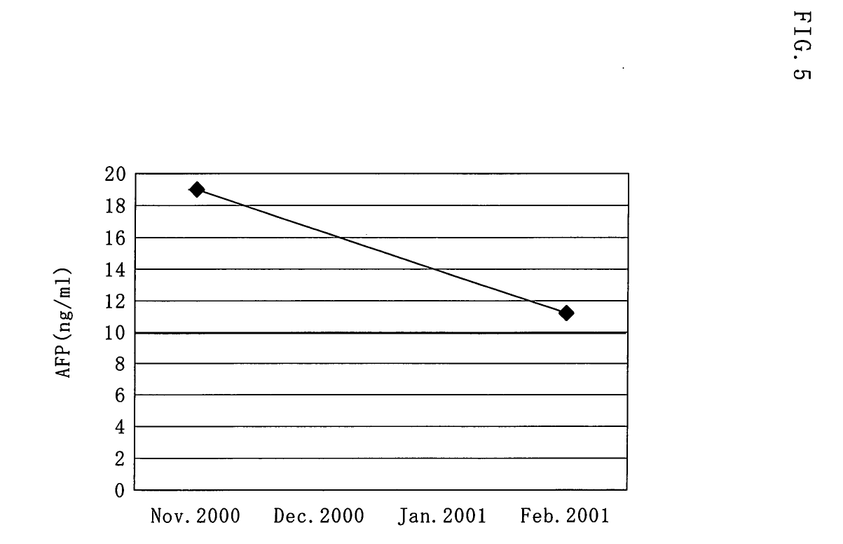

As shown in FIG. 5, in case of a female patient who was at her 60's and had liver cirrhosis and liver cancer had kept drinking 15 milliliters of the beverage produced for a medicinal use three times a day with other functional food such as propolis, Chinese parsley and E-cocci while furthermore taking a far-infrared radiation exposure treatment on the affected part for 10 minutes three times a day, it is clear that the AFP scores (which shows an indicator of seriousness) had been improved.

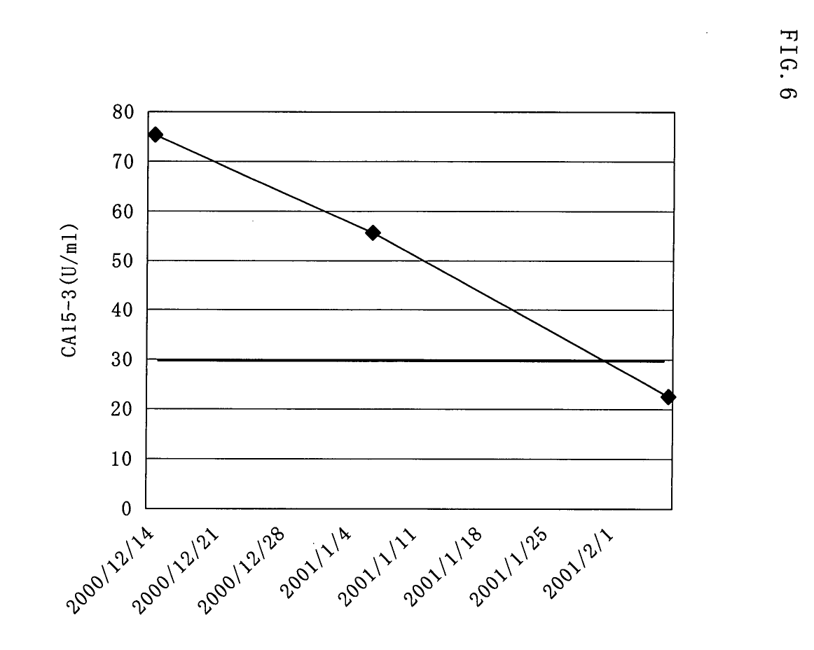

As shown in FIG. 6, in case of a female patient who was at her 50's and had an operation for her cancer of the breast had kept drinking 15 milliliters of the beverage three times a day with other functional food such as propolis and Chinese parsley while taking a far-infrared radiation exposure treatment on the affected part for 10 minutes 3 times a day, it is clear that CA15-3 scores (which shows an indicator of seriousness) had been improved.

In addition, the beverage can be easy to drink with strong green tea flavor as a healthy beverage when a mixing ratio of the chlorophyll-containing compound 16 to the treating water 17 being, for example, 1:400. Furthermore, in case of the mixing ratio being, for example, 1:600, the beverage can have a tasty flavor of green tea.

Furthermore, if soft water is used as the treating water 17, the soft water being purified from a distilled water or a tap water by a water purifier after heating the distilled water or the tap water, the beverage can be prevented from discoloration and generation of a bad smell thereof and can be stayed for 2 to 3 months without using preservatives under a condition of preserving in a refrigerator. Hence, the water purifier is, for example, comprises of a device prevents the tap water from generating a precipitation or turbidity by passing the tap water through layers of ion-exchange resins to remove unpurified substances (including metal ions) affecting water hardness. When the water does not satisfy the above-mentioned condition (4) of the treating water 17, namely when a designated food preservative (e.g. sodium dehydroacetate) is added to the beverage by 0.1%, some chlorophyll-containing compounds 16 dispersed in the beverage (i.e. emulsion) are separated to be black precipitations as time passes. As a result, the beverage will lose product value thereof. Hence, the designated food preservative is an example of that which aggregates the dispersed chlorophyll-containing compound 16. Moreover, the beverage generates a bad smell in two weeks with a proportion of the chlorophyll-containing compound 16 to the treating water 17 being 1 to 60. In the manner, if fine condensibles exist in the beverage, the dispersing state of the chlorophyll-containing compound 16 in the treating water 17 is partially affected, and suspended solids generate in the beverage. Since the suspended solids not only cause the beverage to discolor and rot easily but also generate an offensive order, the beverage loses product value thereof. Namely, although chlorophyll has a character to neutralize and detoxify harmful substances with a particular quality of the chlorophyll, even the preservatives which prevent water from going rotten are harmful substances to the chlorophyll. Accordingly, the chlorophyll-containing compound 16 is preferably diluted with the treating water 17 to preserve the beverage freshly for a long term.

In addition, if a water processed by a device which produces a soft water or an active water (i.e. rot-resistant water) is used as the treating water 17, the beverage can be prevented from discoloring or generating a bad smell, and the beverage can be stayed fresh for one year without using the preservatives under a condition of preserving the beverage in a dark place and in normal temperature (e.g. 10° C. to 25° C.). The device duplicates natural geological layers by piling many porous sintered bodies each of which is molded from a natural disintegrated stone having rot-resistant components. By passing a sterilized water to be the treating water 17 through the device, highly rot-resistant components with rich minerals in the natural stone are extracted in the water. The water is actually circulated through the device so that the water is atomized and activated (i.e. antioxidative water having much activated hydrogen). Hence, the natural stone is one of the group including a natural stone having rot-resistant components, a natural stone softening and alkalizing water, a natural stone activating water, a natural stone magnifying water (e.g. soil beads), several kinds of natural stones purifying water, or poromeric ceramics produced therefrom by pulverization.

Meanwhile, if the chlorophyll-containing compound is dispersed in the tap water without using the treating water 17, the beverage is tinged with brown in about 3 weeks and easily generates a characteristic odor of the chlorophyll-containing compound. In addition, in case of dispersing the chlorophyll-containing compound in the tap water by the ultrasonication, an emulsified status thereof is kept. However, in case of dispersing the chlorophyll-containing compound in the tap water by a homogenizer used ordinarily (i.e. a blender), the chlorophyll-containing compound and the tap water separate into layers.

Further, in case of dispersing the chlorophyll-containing compound in hard water containing a substance which influences hardness of the water (including metal ions) without using the treating water 17, the dispersed and emulsified chlorophyll-containing compound in ultra fine particles are chemically connected with the substance, so that the beverage easily generates a bad odor (in two to three weeks).

For example, when the water does not satisfy the above-mentioned condition (1) of the treating water 17, namely when a powder of Korean ginseng or a powder of planktonic blue-green algae (i.e. vegetative protein containing chlorophyll) is added to the beverage in a small amount, the chlorophyll-containing compound and the water are separated and the beverage rotted (in three to five days).

In addition, when the water does not satisfy the above-mentioned condition (3) of the treating water 17, namely when a natural preservative is dropped to the beverage in a small amount, the beverage is tinged instantly with its scent changed and the beverage lose the product value.

In case of adding natural honey or sugar to the beverage, discoloration and deterioration also occur if the amount thereof is large, so that it is preferable to add small amount of the honey or the sugar to the beverage having a small amount of the chlorophyll-containing compound (i.e. a mixing ratio of the chlorophyll-containing compound 16 to the treating water 17 is 1 to 600 or more than 600). However, the beverage mixed with liquid like an alcoholic drink does not cause deterioration or discoloration (a color of the beverage changes to bright green which is characteristic of alcoholic solution) so that it is possible to produce, for example, an alcoholic beverage with chlorophyll (i.e. the alcoholic beverage containing chlorophyll) by using the beverage.

Table 1 illustrates constituents comprised in the chlorophyll-containing compound. Chlorophyll-a, chlorophyll-b, tocopherol and linolic acid in the table being extracted from the fat and the protein, the weight of which were measured redundantly with weights corresponding to items described below the item of “water”. For instance, the weight of the linolic acid is described as the weight ratio of the fatty acids contained in the fats. Since the chlorophyll-containing compound contains a lot of fat, the chlorophyll-containing compound has difficulty in dispersing in the treating water 17. However, in this embodiment, not only the liquid mixture (A) is stirred with the apparatus 20 having two tanks but also the emulsifying is facilitated by the ultrasonic vibrator 19 while the liquid mixture (A) being transferred, so the emulsifying can be operated, a dispersing status of the chlorophyll being maintained. The beverage having chlorophyll 72 which is a liquid product is taken out by opening such as the third valve 37 installed at the bottom of the second tank 24 and the discharging valve 42 connected thereto after the emulsification is sufficiently developed.

TABLE 1

| ITEM | | RATIO |
|---|---|---|
| Chlorophyll | a | 3.04% |
| Chlorophyll | b | 1.04% |
| Chlorophyll | c | not detected |
| Tocopherol (Vitamin E) | | 63.7 mg |
| Linolic Acid | | 10.4% (in fatty acid) |
| Water | | 24.9% |
| Carbohydrate | | 1.2% |
| Fat (Vegetative Fat) | | 55/4% |
| Protein | | 58.1% |
| Ash | | 10.4% |
| Lead | | not detected (not over 0.002%) |
| Arsenic (AS₂O₃) | | not detected (not over 2 ppm) |
| Viable bacteria count | | 5.1 × 10⁶/g |
| Bacillus Coli | | negative |

As described above, in the method of this embodiment, since the chlorophyll-containing compound is disintegrated into fine particles by the ultrasonic vibrator 19, the dispersing state can be maintained without any surfactant which facilitates emulsifying until the water is rotten in normal temperature. This makes it possible to preserve the beverage having chlorophyll in a drinkable state for a long term.

In the method of this embodiment, by using the excreta of silkworms without any loss, it is possible to produce drinkable chlorophyll emulsion by dispersing the chlorophyll-contained compound in the treating water, and the tablets or the capsulated healthy food by adding fiber to the chlorophyll emulsion or the chlorophyll-containing compound. In addition, the chlorophyll-containing compound is extracted by the ultrasonication, so that the chlorophyll-containing compound can be absorbed easily in human bodies by evenly dispersing the chlorophyll, the fat and the protein.

The embodiment in accordance with the present invention is explained hereinbefore, however the invention is not limited to said embodiment. For example, although the apparatus 20 is used both in the extracting step 12 and the emulsifying step 18, two of the apparatus 20 can be installed independently and the steps can be operated successively. In addition, in the extracting step 12, it is possible to use a conventional extracting method of chlorophyll.

Furthermore, although one ultrasonic vibrator 19 is shared in the embodiment, that the first connection pipe and the second connection pipe can be independent pipes wherein the ultrasonic vibrators are installed respectively.

It is also possible, for example, to add an additive (e.g. sweetner) to the produced emulsion, or to knead the solid material with adding other additives.

### Industrial Applicability

In the method for producing the beverage having chlorophyll in accordance with the present invention, the chlorophyll-containing compound including the oil and/or fat component and a water is emulsified by the ultrasonication and the water satisfying the conditions (1) to (4) is used as the treating water which is the dispersing medium, so that the chlorophyll-containing compound can not only be emulsified to drinkable status by efficiently dispersing the chlorophyll-containing compound in the treating water but also stay fresh for a long term.

In the method, in case of using a pure water as the treating water, it is possible to acquire the treating water having stable quality easily, so that deterioration or discoloration of the beverage having chlorophyll can be retained effectively and the beverage can stay fresh for a long term.

In addition, in order to use the chlorophyll-containing compound as an ingredient of food or cosmetics in liquid status, since the chlorophyll-containing compound is admixed with the other materials of the food or cosmetics sufficiently, it is possible to produce the food or the cosmetics of consistent quality with adjusting a mixing ratio of the chlorophyll-containing compound to the treating water. Accordingly, it is possible to produce the food or the cosmetics of good quality and productivity. Therefore, people in various generations, from children to the elderly, can sufficiently acquire the effect of chlorophyll.

In addition, since the chlorophyll-containing compound can be used for a medicinal use in liquid status by adjusting the mixing ratio of the chlorophyll-containing compound to the treating water, children and the elderly who have difficulty to consume solid medicine (e.g. tablets) can drink the beverage easily and they can sufficiently acquire the effect of chlorophyll.

In addition, the beverage having chlorophyll can be drunk as the healthy beverage which has the effect of chlorophyll with adjusting the mixing ratio of the chlorophyll-containing compound to the treating water, so that the beverage is useful for health management.

Furthermore, the liquid mixture (A) including fat and the treating water is ultrasonicated, so that the liquid mixture (A) can be in drinkable status by the emulsification, and the chlorophyll can be prevented from oxidizing. In addition, the liquid mixture (A) can be alternately transferred between the first tank and the second tank, so that stagnation of the liquid mixture (A) can be decreased in comparison with a case of circulating the liquid mixture (A) in only one tank. As a result, the ultrasonic-dispersion can be carried out equally all over the liquid mixture (A) and the emulsification of all the liquid mixture (A) can be facilitated certainly.

In the method of the present invention, the middle portions of the first and second connection pipes being comprised of the common pipe, the common pipe has the ultrasonic vibrator functioning as not only the first ultrasonic-emulsification device but also the second ultrasonic-emulsification device and the pump providing the liquid mixture (A) to the ultrasonic vibrator arranged in series, so that the apparatus can be made at low cost with less elements of the apparatus.

Also, since both end sides of the first and the second connection pipes are the first to the fourth branch pipes respectively, the first to the fourth branch pipes being connected with inlets and outlets of the first tank and the second tank respectively through the first to the fourth valves, moving directions of the liquid mixture (A) through the common pipe can be the same in cases of the liquid mixture (A) moving from the first tank to the second tank and the liquid mixture (A) moving from the second tank to the first tank. Therefore, the configuration of the pump and the ultrasonic vibrator can be simplified.

Further, the chlorophyll-containing compound is extracted from the excreta of silkworms, so that chlorophyll can be efficiently obtained and purity of chlorophyll contained in the product can be enhanced. In addition, as the ultrasonication is employed to disintegrate the vegetable cell walls and membranes, chlorophyll can be extracted more efficiently.

Furthermore, in the extracting step, the liquid mixture (B) of the volatile solvent and the excreta of silkworms is alternately transferred between the third tank and the fourth tank, so that stagnation of the liquid mixture (B) is decreased in comparison with a case of circulating the liquid mixture (B) in only one tank. As a result, the ultrasonic-emulsification can be carried out equally all over the liquid mixture (B), and also the extraction of chlorophyll can be carried out efficiently.

Furthermore, the tablets are made from the residues produced in the separating step as a side product, so that the health promoting beverage can be mass-produced with eliminating a loss of materials.

1. A method for producing beverage having chlorophyll including a process of dispersing a chlorophyll-containing compound containing an oil and/or fat component, extracted from excreta of silkworms in a treating water, characterized in that the process comprises steps of:
putting the chlorophyll-containing compound and the treating water into a first tank, the treating water being substantially free of: (1) fine solid particles dispersed therein, (2) a bacterium or a virus putrefying the chlorophyll-containing compound, (3) a substance reacting with the chlorophyll-containing compound, and (4) a substance aggregating a dispersion of the chlorophyll-containing compound,
transferring a liquid mixture (A) of the chlorophyll-containing compound and the treating water from the first tank to a second tank through a first connection pipe, the liquid mixture (A) being stirred and mingled in the first tank, the first connection pipe having a first ultrasonic-emulsification device halfway, the liquid mixture (A) being dispersed by an ultrasonic wave with the device, and
returning the liquid mixture (A) in the second tank from the second tank to the first tank through a second connection pipe, the liquid mixture (A) being stirred and mingled in the second tank, the second connection pipe having a second ultrasonic-emulsification device halfway, the liquid mixture (A) being dispersed by the ultrasonic wave with the device,
wherein the chlorophyll-containing compound is blended and dispersed in the treating water to be in an emulsion state by repeating the transferring step and the returning step.

2. A method for producing beverage having chlorophyll according to claim 1, characterized in that the treating water is a pure water.

3. A method for producing beverage having chlorophyll according to claim 1, wherein a mixing ratio of the chlorophyll-containing compound to the treating water is between 1:20 and 1:1000 by weight for using as an ingredient of food besides the beverage.

4. A method for producing beverage having chlorophyll according to claim 1, wherein a mixing ratio of the chlorophyll-containing compound to the treating water is between 1:20 and 1:1000 by weight for using as an ingredient of cosmetics besides the beverage.

5. A method for producing beverage having chlorophyll according to claim 1, wherein a mixing ratio of the chlorophyll-containing compound to the treating water is between 1:30 and 1:1000 by weight for using as a beverage for medicinal purpose.

6. A method for producing beverage having chlorophyll according to claim 1, wherein a mixing ratio of the chlorophyll-containing compound to the treating water is between 1:30 and 1:1000 by weight for using as a health-promoting beverage.

7. A method for producing beverage having chlorophyll according to claim 1 characterized in that:
both end sides of the first and the second connection pipes are comprised of a first to a fourth branch pipes respectively, the first to the fourth branch pipes being connected with liquid inlets and liquid outlets of the first tank and the second tank respectively through a first to a fourth valves,
middle portions of the first and the second connection pipes are comprised of a common pipe whereon an ultrasonic vibrator working as not only the first ultrasonic-emulsification device but also the second ultrasonic-emulsification device, and a pump providing the liquid mixture (A) to the ultrasonic vibrator are arranged in series, and
treatments in the transferring step and the returning step are carried out by switching of the first to the fourth valves with operation of the pump.

8. A method for producing beverage having chlorophyll according to claim 1, characterized in that the chlorophyll-containing compound is obtained by steps of:
extracting the chlorophyll-containing compound from the excreta of silkworms by dissolving the excreta of silkworms containing chlorophyll in a volatile solvent with ultrasonication,
separating unnecessary residues from a liquid produced in the extracting step by a means of filtering or centrifugation, and
evaporating the solvent from a chlorophyll-containing liquid produced in the separating step.

9. A method for producing beverage having chlorophyll according to claim 8, characterized in that:
in the extracting step, a liquid mixture (B) of the volatile solvent and the excreta of silkworms being transferred alternately between a third and a fourth tanks, the third and the fourth tanks being connected with a connection pipe having an ultrasonic-solution device halfway, the liquid mixture (B) being stirred and mingled in the third and the fourth tanks, extraction of chlorophyll contained in the excreta of silkworms is facilitated by the ultrasonic-solution device.

10. A method for producing beverage having chlorophyll according to claim 8, characterized in that tablets are made from the residues produced in the separating step by kneading the residues with the chlorophyll-containing compound or an emulsion including the chlorophyll-containing compound dispersed in the treating water after removing the solvent from the residues by drying.

11. (Canceled).
